(19) United States
(12) Patent Application Publication
(10) Pub. No.: US 2025/0380338 A1
(43) Pub. Date: Dec. 11, 2025

(54) VEHICLE PERFORMING DEFOGGING CONTROL AND METHOD OF CONTROLLING THE SAME

(71) Applicants: HYUNDAI MOTOR COMPANY, SEOUL (KR); KIA CORPORATION, SEOUL (KR)

(72) Inventor: Seung Eun Yu, Hwaseong-si (KR)

(73) Assignees: HYUNDAI MOTOR COMPANY, SEOUL (KR); KIA CORPORATION, SEOUL (KR)

(21) Appl. No.: 18/944,750

(22) Filed: Nov. 12, 2024

(30) Foreign Application Priority Data
Jun. 11, 2024 (KR) 10-2024-0075376

(51) Int. Cl. H05B 1/02; H05B 3/84

(52) U.S. Cl. CPC H05B 1/0236; H05B 3/84

(57) ABSTRACT

A control method of a vehicle includes selecting any one among a plurality of preset auto-defogging modes, each of the plurality of preset auto-defogging modes being set differently based on consideration of an outdoor air blocking condition and an air circulation mode in a defogging control, and performing the defogging control based on the selected auto-defogging mode.

### CROSS REFERENCE TO RELATED APPLICATIONS

The present application claims priority to Korean Patent Application No. 10-2024-0075376, filed Jun. 11, 2024, the entire contents of which is incorporated herein for all purposes by this reference.

### BACKGROUND

### Field of the Present Disclosure

The present disclosure relates to a vehicle that performs effective defogging control in consideration of securing driver's visibility and vehicle's air quality, and a control method thereof.

### Description of Related Art

As moisture contained in warm air inside a vehicle meets cold glass, a fogging phenomenon occurs due to the difference in temperature or humidity between the inside and outside of the vehicle. The fogging phenomenon is a phenomenon of forming frost or fog on the windshield of a vehicle, and when the fogging phenomenon occurs in a driving vehicle, it may obstruct securing driver's visibility and generate a safety problem. Therefore, the frost or fog needs to be removed quickly.

As many of recently released vehicles are equipped with an auto-defogging system that automatically removes frost or fog formed on the windshield of a vehicle, the air conditioning system of the vehicle automatically performs defogging in an outdoor air circulation mode without intervention of a driver to secure driver's visibility.

In addition, as a navigation-based ventilation control system is also applied to vehicles, an outdoor air circulation mode or an indoor air circulation mode is automatically switched according to the outdoor air quality. Therefore, when a vehicle is expected to enter a tunnel in the route or when the outdoor air quality is poor, i.e., when concentration of fine dust is high, it automatically switches to the indoor air circulation mode to secure indoor air quality.

However, since the existing auto-defogging system performs defogging in the outdoor air circulation mode regardless of the air circulation mode determined by the ventilation control system, the auto-defogging system switches to the outdoor air circulation mode when fogging is detected even when the outdoor air quality state is poor.

Those described as the background technique are only to improve understanding of the background of the present disclosure, and should not be accepted by those skilled in the art as recognizing that they correspond to the prior art already known.

### SUMMARY

An object of the present disclosure is to provide a vehicle that performs effective defogging control in consideration of securing driver's visibility and vehicle's air quality, and a control method thereof.

The technical problems to be solved by the present disclosure are not limited to the technical problems mentioned above, and unmentioned other technical problems will be clearly understood by those skilled in the art from the following description.

A control method of a vehicle of the present disclosure for achieving the above object may include the steps of: selecting any one among a plurality of preset auto-defogging modes, each of the plurality of preset auto-defogging modes being set differently in terms of whether or not to consider an outdoor air blocking condition and an air circulation mode in a defogging control; and performing the defogging control based on the selected auto-defogging mode.

In the control method of a vehicle of the present disclosure, the step of performing the defogging control based on the selected auto-defogging mode may be performed based on a result of comparing a reference fog amount configured to enter the defogging control with a current fog amount.

In the control method of a vehicle of the present disclosure, the plurality of auto-defogging modes may include a first mode of performing the defogging control in an outdoor air circulation mode, a second mode of switching the air circulation mode in response that an outdoor air blocking condition is satisfied or expected to be satisfied;, and a third mode of performing the defogging control preferentially in an indoor air circulation mode.

In the control method of a vehicle of the present disclosure, the first mode may maintain the outdoor air circulation mode at all times in the defogging control.

In the control method of a vehicle of the present disclosure, in the second mode, in response that the outdoor air blocking condition is satisfied, the defogging control may be performed in the indoor air circulation mode, and in response that the outdoor air blocking condition is expected to be satisfied, the defogging control may be performed in the outdoor air circulation mode until the outdoor air blocking condition is satisfied.

In the control method of a vehicle of the present disclosure, the case where the outdoor air blocking condition is expected to be satisfied may include a case where it is determined that there is an air quality deterioration section ahead.

In the control method of a vehicle of the present disclosure, a time point of entering the defogging control may be determined considering a remaining distance to the air quality deterioration section so that defogging is completed before entering the air quality deterioration section.

In the control method of a vehicle of the present disclosure, a reference fog amount configured to enter the defogging control in the third mode may be lower than those of the first mode and the second mode.

In the control method of a vehicle of the present disclosure, in the third mode, in response that a preset reference fog amount reduction ratio is not satisfied while performing the defogging control in the indoor air circulation mode, the defogging control may be performed in the outdoor air circulation mode.

In the control method of a vehicle of the present disclosure, the step of selecting any one among a plurality of preset auto-defogging modes may include the steps of: learning at least one among a time point of handling a defogging button by a user and a ratio of maintaining the air circulation mode; and selecting any one among the plurality of auto-defogging modes based on a result of the learning.

The vehicle according to the present disclosure may include an air conditioning device, and a controller configured to control, in response that any one among a plurality of preset auto-defogging modes is selected, the air conditioning device to perform a defogging control based on the selected auto-defogging mode, wherein each of the plurality of preset auto-defogging modes are set differently in terms of whether or not to consider an outdoor air blocking condition and an air circulation mode in the defogging control.

The vehicle of the present disclosure, may further include a sensing unit for detecting a current indoor fog amount, wherein the controller controls entering the defogging control based on a result of comparing a reference fog amount configured to enter the defogging control with a current fog amount.

In the vehicle of the present disclosure, the plurality of auto-defogging modes may include a first mode of performing the defogging control in an outdoor air circulation mode, a second mode of switching the air circulation mode in response that an outdoor air blocking condition is satisfied or expected to be satisfied, and a third mode of performing the defogging control preferentially in an indoor air circulation mode.

In the vehicle of the present disclosure, the controller may be further configured to maintain the outdoor air circulation mode at all times in the defogging control in the first mode.

In the vehicle of the present disclosure, in the second mode, in response that the outdoor air blocking condition is satisfied, the defogging control may be performed in the indoor air circulation mode, and in response that the outdoor air blocking condition is expected to be satisfied, the defogging control may be performed in the outdoor air circulation mode until the outdoor air blocking condition is satisfied.

In the vehicle of the present disclosure, the case where the outdoor air blocking condition is expected to be satisfied may include a case where it is determined that there is an air quality deterioration section ahead.

In the vehicle of the present disclosure, the controller may be further configured to determine a time point of entering the defogging control considering a remaining distance to the air quality deterioration section so that defogging is completed before entering the air quality deterioration section.

In the vehicle of the present disclosure, a reference fog amount configured to enter the defogging control in the third mode may be lower than those of the first mode and the second mode.

In the vehicle of the present disclosure, in the third mode, in response that a preset reference fog amount reduction ratio is not satisfied while performing the defogging control in the indoor air circulation mode, the defogging control may be performed in the outdoor air circulation mode.

In the vehicle of the present disclosure, the controller may be further configured to learn at least one among a time point of handling a defogging button by a user and a ratio of maintaining the air circulation mode, and select any one among the plurality of auto-defogging modes based on a result of the learning.

According to a vehicle that performs defogging control of the present disclosure and a control method thereof, driver's driving safety can be improved by securing the driver's visibility and maximally securing the air quality inside the vehicle through preemptive defogging control that reflects the intention of the driver without driver's direct handling of the air circulation mode for defogging control.

The effects that can be obtained from the present disclosure are not limited to the effects mentioned above, and unmentioned other effects can be clearly understood by those skilled in the art from the following description.

### BRIEF DESCRIPTION OF THE FIGURES

FIG. 1 is a view showing a vehicle device and information for performing defogging control according to an embodiment of the present disclosure.

FIG. 2 is a view showing a plurality of auto-defogging modes and characteristics thereof provided by the defogging control device shown in FIG. 1.

FIG. 3 is a flowchart illustrating the process of selecting the plurality of auto-defogging modes shown in FIG. 2 and the order of outputting the auto-defogging modes.

FIG. 4 is a flowchart illustrating a defogging control method of a first mode among the plurality of auto-defogging modes shown in FIG. 3.

FIG. 5 is a flowchart illustrating a defogging control method of a second mode among the plurality of auto-defogging modes shown in FIG. 3.

FIG. 6 is a view showing a state in which the current outdoor air blocking condition is satisfied in the defogging control method of the second mode shown in FIG. 5.

FIG. 7 is a view showing a state in which the outdoor air blocking condition is expected to be satisfied in the defogging control method of the second mode shown in FIG. 5.

FIG. 8 is a flowchart illustrating a defogging control method of a third mode among the plurality of auto-defogging modes shown in FIG. 3.

FIG. 9 is a view showing a state in which a reference fogging reduction ratio is satisfied in the defogging control method of the third mode shown in FIG. 8.

### DETAILED DESCRIPTION

When it is determined, in describing the embodiments disclosed in this specification, that the detailed descriptions of related known techniques may obscure the gist of the embodiments disclosed in this specification, the detailed description will be omitted. In addition, the accompanying drawings are only for easy understanding of the embodiments disclosed in this specification, and the technical spirit disclosed in this specification is not limited by the accompanying drawings, and should be understood to include all changes, equivalents, and substitutes included in the spirit and technical scope of the present disclosure.

Although terms including ordinal numbers such as first, second, and the like may be used to describe various components, the components are not limited by the terms. The terms are used only to distinguish one component from the others.

Singular expressions include plural expressions unless the context clearly dictates otherwise.

In this specification, terms such as “comprise”, “have”, and the like are intended to indicate presence of a feature, a number, a step, an operation, a component, part, or a combination thereof described in the specification, and it should be understood that the terms do not preclude the possibility of presence or addition of one or more other features, numbers, steps, operations, components, parts, or combinations thereof.

When a component is mentioned as being “connected” or “coupled” to another component, it should be understood that although the component may be directly connected or coupled to another component, other components may exist in the middle. On the contrary, when a component is mentioned as being “directly connected” or “directly coupled” to another element, it should be understood that no other component exists in the middle.

A controller may include a communication device that communicates with other controllers or sensors to control the functions in charge of, a memory that stores the operating system, logic commands, input/output information, and the like, and one or more processors that perform determinations, calculations, and decisions needed for controlling the functions in charge of.

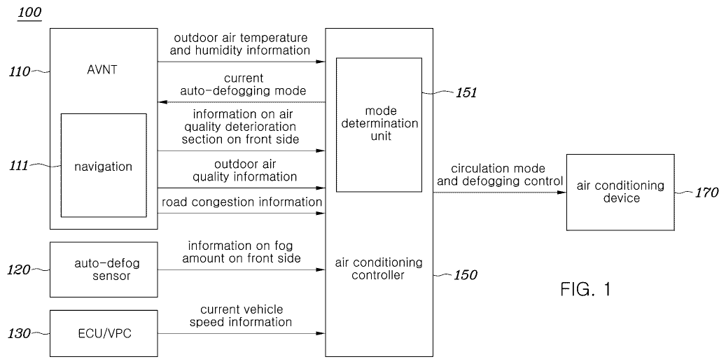

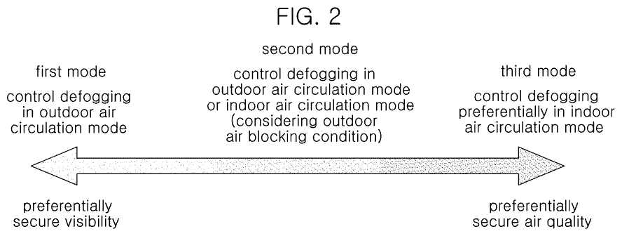

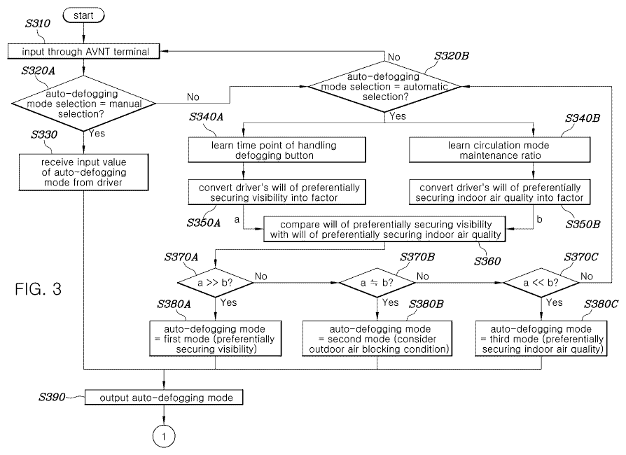

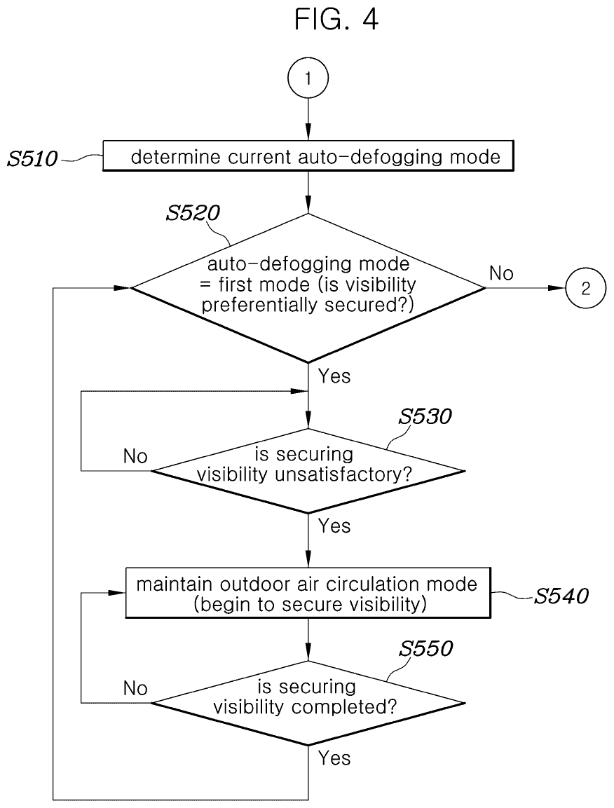

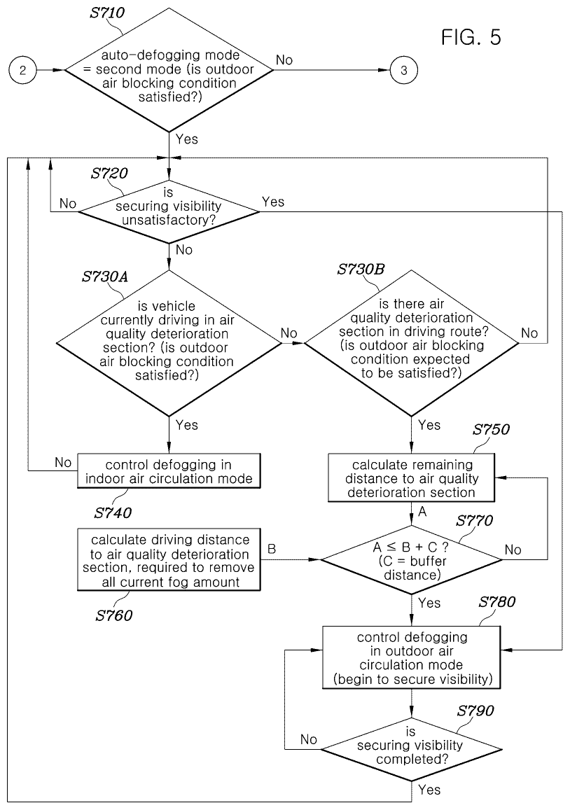

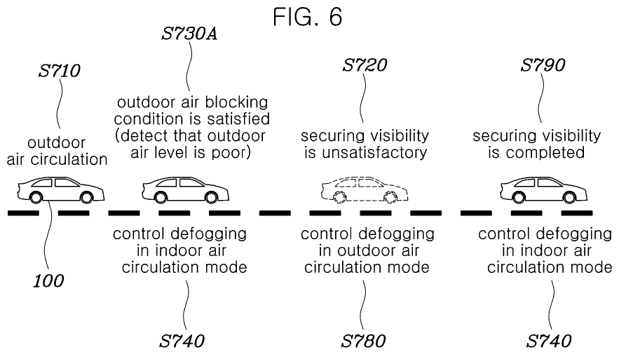

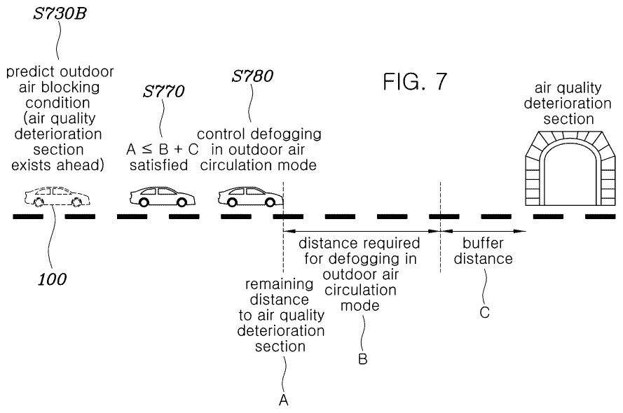

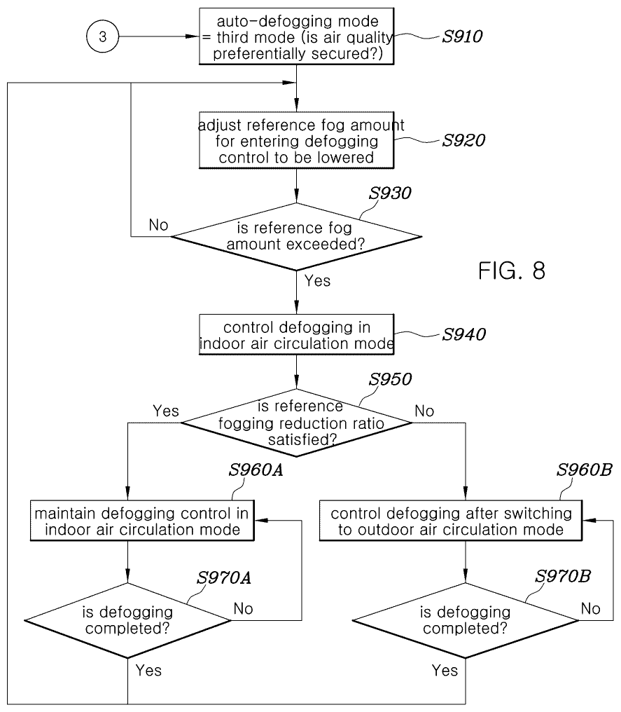

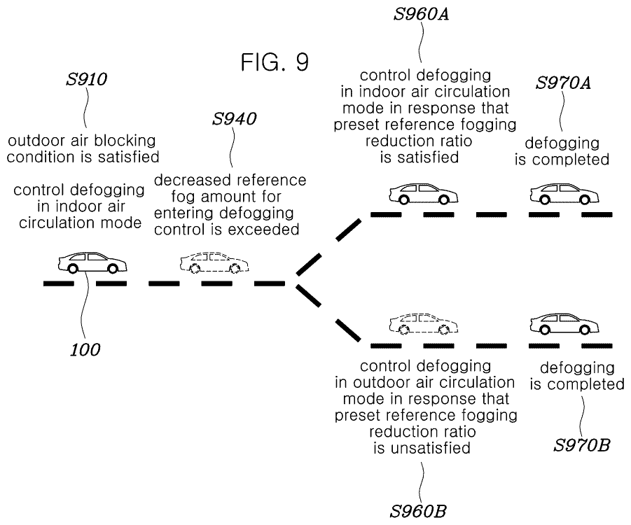

FIG. 1 is a view showing a vehicle device and information for performing defogging control according to an embodiment of the present disclosure, FIG. 2 is a view showing a plurality of auto-defogging modes and characteristics thereof provided by the defogging control device shown in FIG. 1, FIG. 3 is a flowchart illustrating the process of selecting the plurality of auto-defogging modes shown in FIG. 2 and the order of outputting the auto-defogging modes, FIG. 4 is a flowchart illustrating a defogging control method of a first mode among the plurality of auto-defogging modes shown in FIG. 3, FIG. 5 is a flowchart illustrating a defogging control method of a second mode among the plurality of auto-defogging modes shown in FIG. 3, FIG. 6 is a view showing a state in which the current outdoor air blocking condition is satisfied in the defogging control method of the second mode shown in FIG. 5, FIG. 7 is a view showing a state in which the outdoor air blocking condition is expected to be satisfied in the defogging control method of the second mode shown in FIG. 5, FIG. 8 is a flowchart illustrating a defogging control method of a third mode among the plurality of auto-defogging modes shown in FIG. 3, and FIG. 9 is a view showing a state in which a reference fogging reduction ratio is satisfied in the defogging control method of the third mode shown in FIG. 8.

Hereinafter, the embodiments disclosed in this specification will be described in detail with reference to the accompanying drawings, and the same reference numerals are given to the same or similar components regardless of reference symbols, and duplicate description thereof will be omitted.

The fogging phenomenon of a vehicle is a phenomenon of forming frost or fog on the windshield or windows of the vehicle, and this means a phenomenon of condensing water vapor on the inner side of the windows of the vehicle and blurring the vision like fog. In particular, the fogging phenomenon may occur by various reasons, such as when the difference of temperature between the inside and outside of the vehicle is large, when the humidity inside the vehicle is high, when ventilation is insufficient, and the like.

The embodiments of the present disclosure propose a defogging control method for defogging of a vehicle 100 to secure both convenience and safety of the driver as the vehicle 100 learns information on handling the air circulation mode by the driver in controlling defogging and the outdoor air blocking condition.

First, the configuration of the vehicle 100 that can be applied to the embodiments will be described with reference to FIG. 1.

Referring to FIG. 1, the vehicle 100 that can be applied to the embodiments may include an Audio Video Navigation Telematics (AVNT) terminal 110, an auto-defog sensor 120, a driving system controller 130, an air conditioning controller 150, and an air conditioning device 170. Each component will be described below in detail.

The AVNT terminal 110 is a device that combines connected car services and is equipped with media and navigation 111 functions, and may acquire temperature and humidity information of the air outside the vehicle 100 through the connected car services or the like. In addition, through the navigation 111 function, the AVNT terminal 110 may acquire information on the sections ahead where air quality will be deteriorated, information on the outdoor air quality, and information on whether there is traffic congestion on the road.

The auto-defog sensor 120 may be installed in the rearview mirror or the like of the vehicle 100 to detect the fogging level of the vehicle glass. Of course, the auto-defog sensor 120 is an example, and it is not necessarily limited thereto when the auto-defog sensor 120 may detect or predict the degree of indoor fogging.

The driving system controller 130 may generally mean a controller involved in controlling the driving source of the vehicle 100, and may output vehicle speed information in relation to the embodiments. In the implementation, although the driving system controller 130 may be implemented as an Engine Control Unit (ECU) in an internal combustion engine vehicle and implemented as a vehicle platform controller (VPC) in an electric vehicle, this is an example, and it is sufficient and not necessarily limited thereto when the driving system controller 130 may output vehicle speed information.

The air conditioning controller 150 may basically control the overall function of the air conditioning device 170, and in particular, may control the auto-defogging function according to the embodiments. More specifically, the air conditioning controller 150 may acquire outdoor air temperature and humidity information, air quality deterioration section information on the front side, outdoor air quality information, road congestion information, and the like from the AVNT terminal 110, and may acquire information on the fog amount from the auto-defog sensor 120. In addition, the air conditioning controller 150 may acquire current vehicle speed information from the driving system controller 130. The air conditioning controller 150 may determine any one among a plurality of auto-defogging modes based on the acquired information, and perform defogging by controlling the air conditioning device 170 according to conditions set for each determined auto-defogging mode. To this end, the air conditioning controller 150 may include a mode determination unit 151 for determining any one among a plurality of auto-defogging modes. The plurality of auto-defogging modes will be described below in more detail with reference to FIG. 2.

Meanwhile, the air conditioning controller 150 may provide information on the determined current auto-defogging mode to the AVNT terminal 110 so that the AVNT terminal 110 may output information on the auto-defogging mode.

Although it is assumed in FIG. 1 that the determination subject related to the auto-defogging function according to the embodiments is the air conditioning controller 150, this is an example, and it is not necessarily limited thereto. For example, determination on the auto-defogging control may be performed by another controller (e.g., the AVNT 110 terminal, a separate controller for auto-defogging control, or the like) different from the air conditioning controller 150, and it may also be implemented in a form that transfers only a control command corresponding to a result of the determination to the air conditioning controller 150.

Next, a plurality of auto-defogging modes according to an embodiment will be described with reference to FIG. 2.

Referring to FIG. 2, the auto-defogging mode may include three modes of a first mode, a second mode, and a third mode. Each mode may be set in advance to change the air circulation mode in controlling defogging and whether or not to consider an outdoor air blocking condition.

More specifically, the first mode is a mode that performs defogging control in an outdoor air circulation mode, and since it involves the outdoor air circulation mode, the first mode among the modes may perform defogging most effectively and is suitable for securing driver's visibility.

The third mode may perform defogging control preferentially in the indoor air circulation mode, and may selectively switch to the outdoor air circulation mode when defogging performance is insufficient. Therefore, the third mode is suitable for securing indoor air quality as the outdoor air circulation mode is selected in a limited manner.

The second mode is a mode of an intermediate form between the first mode and the third mode of securing visibility and air quality, and may mean a mode of performing defogging control by selecting an air circulation mode in consideration of an outdoor air blocking condition.

For example, when there is an outdoor air blocking condition, i.e., when there is a tunnel or a section where fine dust concentration is worsened on the front side, in the first mode, defogging is performed in the outdoor air circulation mode regardless of the outdoor air blocking condition. In addition, in the third mode, although the outdoor air blocking condition is not satisfied, defogging is performed preferentially in the indoor air circulation mode. On the contrary, when there is an area ahead where the outdoor air blocking condition is satisfied, in the second mode, vehicle speed information is acquired from the driving system controller 130, and a time point of performing defogging is determined based on the acquired vehicle speed information so that the defogging may be performed as much as possible in the outdoor air circulation mode before the vehicle reaches the area.

Hereinafter, the control method of the vehicle 100 according to an embodiment will be described with reference to FIGS. 3 to 9. The control method according to an embodiment includes a step of selecting any one among a plurality of preset auto-defogging modes to change the air circulation mode in controlling defogging and whether or not to consider an outdoor air blocking condition (FIG. 3), and a step of performing defogging control based on the selected auto-defogging mode (FIGS. 4, 5, and 8).

First, the process of selecting one among a plurality of auto-defogging modes will be described with reference to FIG. 3.

Referring to FIG. 3, a driver may input a command for selecting an auto-defogging mode through the AVNT 110 terminal (S310). When the driver's command corresponds to manual selection (Yes of S320A), the auto-defogging mode may be selected according to a value input by the driver through the mode determination unit 151 of the air conditioning controller 150 (S330).

On the contrary, when the driver's command corresponds to automatic selection (No of S320A & Yes of S320B), the mode determination unit 151 of the air conditioning controller 150 may select the auto-defogging mode through learning. Here, the learning target may include a time point of handling a defogging button and a ratio of maintaining the air circulation mode.

More specifically, the mode determination unit 151 may learn the time point of handling the defogging button (S340A), and convert the driver's will of preferentially securing visibility into a factor (a of S350A). This is since that the driver's behavior of manually handling the defogging button before the auto-defogging function operates means that the driver feels that the driver's visibility is obstructed even by a fog amount smaller than a preset reference fog amount for entering auto-defogging, and this may mean that the driver's will of securing visibility is strong. Therefore, the lower the amount of fog at the time point of handling the defogging button is than the reference fog amount for entering auto-defogging, the greater the driver's will of preferentially securing visibility will be converted into a factor (a).

In addition, the mode determination unit 151 may also learn an air circulation mode maintenance ratio (S340B), and through this, the driver's will of preferentially securing the indoor air quality will be converted into a factor (b of S350B). For example, the longer the time period of maintaining the state of operating in the indoor air circulation mode after the driver handles the indoor air circulation mode switch button when the outdoor air circulation mode is set as the default setting, the greater the will of preferentially securing the indoor air quality will be converted into a factor. Therefore, the higher the ratio of maintaining the indoor air circulation mode while driving, the greater the driver's will of preferentially securing the indoor air quality of the vehicle 100 will be converted into a factor (b).

The mode determination unit 151 of the air conditioning controller 150 may select an appropriate auto-defogging mode by learning and quantifying the driver's will of preferentially securing visibility (a) and the will of preferentially securing the indoor air quality (b), and comparing the quantified values (S360).

More specifically, when the quantified value (a) of the driver's will of preferentially securing visibility is greater than the quantified value (b) of the driver's will of preferentially securing the indoor air quality as much as a preset value or a preset ratio or more, it means that the driver's will of preferentially securing visibility is stronger, and the first mode may be selected in the auto-defogging mode (S380A). Accordingly, as defogging control is performed in the outdoor air circulation mode, the driver may effectively secure visibility.

On the contrary, when the quantified value (b) of the driver's will of preferentially securing the indoor air quality is greater than the quantified value (a) of the driver's will of preferentially securing visibility as much as a preset value or a preset ratio or more, it means that the driver's will of preferentially securing the indoor air quality is stronger, and the third mode may be selected in the auto-defogging mode (S380C). Accordingly, defogging control in the vehicle 100 may be performed preferentially in the indoor air circulation mode, and when defogging performance is insufficient, it may be selectively switched to the outdoor air circulation mode.

When the quantified value (a) of the driver's will of preferentially securing visibility is equal to the quantified value (b) of the driver's will of preferentially securing the indoor air quality or the difference is smaller than a preset value or a preset ratio, the second mode may be selected by the mode determination unit 151 of the air conditioning controller 150 (S380B). The second mode of the auto-defogging mode is a mode that has intermediate characteristics of the first mode and the third mode between securing the driver's visibility and securing the indoor air quality, and when the driver's will of securing visibility and the will securing the indoor air quality are at a similar level, defogging control may be performed by additionally considering an outdoor air blocking condition.

The mode determination unit 151 of the air conditioning controller 150 may provide information on the current auto-defogging mode to the driver through the AVNT 110 terminal (S390) by outputting an auto-defogging mode manually selected by the driver (Yes at 320A) or an auto-defogging mode selected through learning (S380A, S380B, S380C) when the driver's command corresponds to automatic selection (No of S320A & Yes of S320B).

Next, the step of performing defogging control based on the selected auto-defogging mode will be described with reference to FIGS. 4, 5, and 8.

First, the step of performing defogging control when the first mode is selected among a plurality of auto-defogging modes will be described with reference to FIG. 4.

The air conditioning controller 150 may determine the current auto-defogging mode (S510), and when the current auto-defogging mode is the first mode (Yes of S520) and securing the driver's visibility is unsatisfactory (Yes of S530), it may perform defogging while maintaining the outdoor air circulation mode (S540). Defogging through maintaining the outdoor air circulation mode may be performed until securing the visibility is completed (S550).

Here, the state that securing the visibility is unsatisfactory may mean that the amount of fog detected through the auto-defog sensor 120 reaches a reference fog amount for entering defogging control. In addition, the state that securing the visibility is completed may mean a state in which the amount of fog detected through the auto-defog sensor 120 is reduced to be lower than a predetermined level. At this point, the predetermined level may be equal to or lower than the reference fog amount for entering defogging control.

Next, the step of performing defogging control in the second mode (Yes of S710) when the current auto-defogging mode in FIG. 4 is not the first mode (No of S520) will be described with reference to FIG. 5.

When the current auto-defogging mode is the second mode (Yes of S710) and visibility is secured (No of S720), the air conditioning controller 150 may determine whether the current position of the vehicle 100 is within an air quality deterioration section (S730A). When the vehicle is driving in the air quality deterioration section (Yes of S730A), defogging control may be performed in the indoor air circulation mode as it is in a state where the outdoor air blocking condition is satisfied (S740). That is, since the second mode is a mode that has intermediate characteristics between the first mode that preferentially secures the driver's visibility and the third mode that preferentially secures the indoor air quality of the vehicle 100, when it is worried that the indoor air quality is deteriorated as the current outdoor air blocking condition is satisfied in a state where securing visibility is satisfied, defogging control may be performed by switching to the indoor air circulation mode (S740).

On the contrary, when the vehicle is currently not in a situation of driving in an air quality deterioration section (No of S730A), but there is an air quality deterioration section in the driving route (i.e., when the outdoor air blocking condition is expected to be satisfied, Yes of S730B), the air conditioning controller 150 may control the air conditioning device 170 to perform defogging in the outdoor air circulation mode as much as possible before entering the corresponding section. To this end, the air conditioning controller 150 may determine the remaining distance (A) to the air quality deterioration section (S750), and perform defogging control in the outdoor air circulation mode (S780) considering the driving distance (B) and the buffer distance (C) required to remove all the current amount of fog before reaching the air quality deterioration section (S770).

For example, when the remaining distance (A) to the air quality deterioration section is smaller than or equal to the sum of the driving distance (B) and the buffer distance (C) required to remove all the current amount of fog before reaching the air quality deterioration section (Yes in S770), the air conditioning controller 150 may secure visibility by controlling defogging in the outdoor air circulation mode before entering the air quality deterioration section (S780).

Here, the buffer distance (C) may mean a margin of the driving distance (B) required to remove all the current amount of fog of the vehicle 100 before reaching the air quality deterioration section. Therefore, although the driver's visibility should be secured basically by performing defogging control through the outdoor air circulation mode before reaching the buffer distance (C), when securing visibility is not completed before reaching the buffer distance (C), securing visibility may be additionally performed before entering the air quality deterioration section using the buffer distance (C) (S780).

On the other hand, when there is a section in the driving route where air quality is expected to be deteriorated (Yes of S730B), since air quality should be preferentially considered in the section where air quality is deteriorated, it may be focused on securing driver's visibility by controlling defogging in advance in the outdoor air circulation mode before entering the section where air quality is deteriorated (S780).

Meanwhile, when the current auto-defogging mode is the second mode (Yes of S710) and securing the visibility is unsatisfactory (Yes of S720), the air conditioning controller 150 may control the air conditioning device 170 to perform defogging control in the outdoor air circulation mode (S780). Accordingly, the air conditioning device 170 of the vehicle 100 may quickly secure visibility by controlling defogging in the outdoor air circulation mode.

When the reference of dissatisfaction in securing visibility (S530) mentioned in the first mode of FIG. 4 is the same as the reference of dissatisfaction in securing visibility (S720) of FIG. 5, this may mean that steps S730A, S740, S730B, S750, S760, and S770 are performed at all times. On the contrary, when the reference of dissatisfaction in securing visibility (S530) of FIG. 4 is different from the reference of dissatisfaction in securing visibility (S720) of FIG. 5, the reference of dissatisfaction in securing visibility (S720) of FIG. 5 may be higher than the reference of dissatisfaction in securing visibility of FIG. 4 (S530, i.e., the reference fog amount for entering defogging control). In this case, steps S730A, S740, S730B, S750, S760, and S770 may be performed when the amount of fog detected through the auto-defog sensor 120 is higher than the reference fog amount for entering defogging control.

The auto-defogging control in the second mode described above with reference to FIG. 5 will be described below assuming a specific situation with reference to FIGS. 6 and 7.

FIGS. 6 and 7 commonly assume that the vehicle 100 moves from the left to the right as time passes.

Referring to FIG. 6, the current auto-defogging mode is the second mode (S710) and the vehicle 100 drives in the outdoor air circulation mode. When the vehicle 100 enters an air quality deterioration section (e.g., a tunnel or a section with a high concentration of fine dust) in a state where securing visibility is satisfied (No of S720 in FIG. 5) (730A), the air conditioning device 170 may performed defogging control by switching to the indoor air circulation mode (S740).

On the other hand, since defogging performance in the indoor air circulation mode may be lower than that of the outdoor air circulation mode, securing the driver's visibility may be unsatisfactory in a state where the outdoor air blocking condition is satisfied (S720). In this case, the air conditioning device 170 may perform defogging control by switching to the outdoor air circulation mode (S780). When securing the driver's visibility is completed by performing defogging control in the outdoor air circulation mode (Yes of S790), it is possible to respond to the deteriorated outdoor air level by performing defogging control in the indoor air circulation mode again (S740).

FIG. 7 is a view showing the step of performing defogging control when there is a section in the driving route where air quality will be deteriorated, and the process of performing defogging control in the second mode in this case is described.

When the outdoor air blocking condition is expected to be satisfied (S730B) as there is a section where air quality will be deteriorated in the driving route in a state where the current auto-defogging mode is the second mode (Yes of S710 of FIG. 5), the air conditioning controller 150 may perform preemptive defogging in the outdoor air circulation mode before entering the section.

More specifically, the air conditioning controller 150 may calculate the remaining distance (A) to the air quality deterioration section, and the driving distance (B) and the buffer distance (C) required to remove all the current amount of fog before reaching the air quality deterioration section (S750 and S760 of FIG. 5). When the sum of the driving distance (B) and the buffer distance (C) required to remove all the current amount of fog before reaching the air quality deterioration section is larger than or equal to the remaining distance (A) to the air quality deterioration section (S770), the air conditioning controller 150 performs defogging control in the outdoor air circulation mode (S780). Accordingly, before entering the air quality deterioration section, the vehicle 100 removes the current amount of fog as much as possible using the buffer distance (C) if necessary, through the outdoor air circulation mode. Therefore, the vehicle may enter the air quality deterioration section in a state where the driver's visibility is secured sufficiently through the outdoor air circulation mode, and the indoor air quality of the vehicle 100 may be sufficiently secured in the air quality deterioration section through the indoor air circulation mode.

The step of performing defogging control when the third mode is selected among a plurality of auto-defogging modes will be described with reference to FIG. 8.

When the current auto-defogging mode is neither the first mode (No of S520 of FIG. 4) nor the second mode (No of S710 of FIG. 5), i.e., when the current auto-defogging mode is the third mode (S910), the reference fog amount for entering defogging control may be adjusted to be lower than a preset value (S920). This is since that the third mode should perform defogging control preferentially in the indoor air circulation mode unlike the first or second mode, even when the amount of fog detected through the auto-defog sensor 120 exceeds the preset reference fog amount for starting defogging control.

When the lowered reference fog amount for entering defogging control is satisfied (Yes of S950), the air conditioning controller 150 may control the air conditioning device 170 to perform defogging control preferentially through the indoor air circulation mode. When a preset reference fogging reduction ratio is satisfied while performing defogging control in the indoor air circulation mode (Yes of S950), the air conditioning controller 150 may continuously maintain defogging control in the indoor air circulation mode (S960A) until the defogging is completed (S970A).

On the contrary, when the preset reference fogging reduction ratio is not satisfied in performing defogging control in the indoor air circulation mode (No of S950), the air conditioning controller 150 may control the air conditioning device 170 to temporarily switch to the outdoor air circulation mode and perform defogging control to secure the driver's visibility (S960B). The outdoor air circulation mode may be maintained until the defogging is completed (No in S970B), and when defogging is completed, defogging control may be performed in the indoor air circulation mode again (Yes of S970B).

Hereinafter, auto-defogging control of the third mode described in FIG. 8 will be described assuming a specific situation with reference to FIG. 9. In FIG. 9, it may be assumed that the vehicle 100 moves from the left to the right as time passes.

When the current auto-defogging mode is the third mode (Yes of S910 of FIG. 8), the air conditioning controller 150 may perform defogging control in the indoor air circulation mode so that outdoor air of deteriorated quality may not flow into the vehicle 100 (S910). In the third mode, the preset reference fog amount for entering defogging control may be adjusted to be lower than that of the first mode or the second mode (S920 in FIG. 8). This is since that as the third mode is an auto-defogging mode in which the driver's will of preferentially securing indoor air quality is learned, defogging control should be performed preferentially in the indoor air circulation mode.

More specifically, when the current amount of fog exceeds the lowered reference fog amount for entering defogging control (Yes of S930 of FIG. 8), the air conditioning controller 150 may control the air conditioning device 170 to perform defogging control preferentially in the indoor air circulation mode (S940). However, although the third mode preferentially secures indoor air quality, securing the driver's visibility may also be considered. Therefore, in the third mode, in order to secure the driver's visibility, defogging control may be performed by switching to the outdoor air circulation mode (S950) according to whether or not the reference fogging reduction ratio is satisfied in a state where defogging control is performed in the indoor air circulation mode (S940).

Specifically, when the amount of fog detected through the auto-defog sensor 120 satisfies the preset reference fogging reduction ratio while the air conditioning controller 150 performs defogging control in the indoor air circulation mode (Yes of S950 of FIG. 8), the air conditioning device 170 may preferentially secure indoor air quality by continuously performing defogging control in the indoor air circulation mode until the defogging is completed (S960A, S970A).

On the contrary, when the current amount of fog does not satisfy the preset reference fogging reduction ratio while performing defogging control in the indoor air circulation mode (No of S950 of FIG. 8), the air conditioning device 170 may perform defogging control by temporarily switching to the outdoor air circulation mode (S960B). The air conditioning device 170 may secure the driver's visibility by switching to the outdoor air circulation mode and performing defogging control until the defogging is completed (S960B, S970B). Therefore, when the driver's visibility is not secured due to fogging even in the third mode of preferentially securing indoor air quality, defogging control may be performed by switching to the outdoor air circulation mode for the sake of driving safety.

Although the present disclosure has been shown and described in relation to specific embodiments, it is apparent to those skilled in the art that the present disclosure can be modified and changed in various ways without departing from the technical spirit of the present disclosure as provided by the following claims.

1. A control method of a vehicle, the method comprising:
selecting, by a controller, any one among a plurality of preset auto-defogging modes, each of the plurality of preset auto-defogging modes being set differently based on consideration of an outdoor air blocking condition and an air circulation mode in a defogging control; and
performing the defogging control based on the selected auto-defogging mode.

2. The control method of a vehicle of claim 1, wherein performing the defogging control based on the selected auto-defogging mode is performed based on a result of comparing a reference fog amount configured to enter the defogging control with a current fog amount.

3. The control method of a vehicle of claim 1, wherein the plurality of auto-defogging modes includes:
a first mode of performing the defogging control in an outdoor air circulation mode;
a second mode of switching the air circulation mode when an outdoor air blocking condition is satisfied or expected to be satisfied; and
a third mode of performing the defogging control preferentially in an indoor air circulation mode.

4. The control method of a vehicle of claim 3, wherein the first mode maintains the outdoor air circulation mode at all times in the defogging control.

5. The control method of a vehicle of claim 3, wherein in the second mode, when the outdoor air blocking condition is satisfied, the defogging control is performed in the indoor air circulation mode, and when the outdoor air blocking condition is expected to be satisfied, the defogging control is performed in the outdoor air circulation mode until the outdoor air blocking condition is satisfied.

6. The control method of a vehicle of claim 5, wherein the outdoor air blocking condition is expected to be satisfied includes a case where there is an air quality deterioration section ahead.

7. The control method of a vehicle of claim 6, wherein a time point of entering the defogging control is determined considering a remaining distance to the air quality deterioration section so that defogging is completed before entering the air quality deterioration section.

8. The control method of a vehicle of claim 3, wherein a reference fog amount configured to enter the defogging control in the third mode is lower than a reference fog amount of the first mode and a reference fog amount of the second mode.

9. The control method of a vehicle of claim 3, wherein in the third mode, when a preset reference fog amount reduction ratio is not satisfied while performing the defogging control in the indoor air circulation mode, the defogging control is performed in the outdoor air circulation mode.

10. The control method of a vehicle of claim 1, wherein selecting any one among a plurality of preset auto-defogging modes includes the steps of:
learning at least one among a time point of handling a defogging button by a user and a ratio of maintaining the air circulation mode; and
selecting any one among the plurality of auto-defogging modes based on a result of the learning.

11. A vehicle comprising:
an air conditioning device; and
a controller configured to control, when any one among a plurality of preset auto-defogging modes is selected, the air conditioning device to perform a defogging control based on the selected auto-defogging mode;
wherein each of the plurality of preset auto-defogging modes are set differently based on consideration of an outdoor air blocking condition and an air circulation mode in the defogging control.

12. The vehicle of claim 11, further comprising a sensing unit configured to detect a current indoor fog amount, wherein the controller is further configured to control entering the defogging control based on a result of comparing a reference fog amount configured to enter the defogging control with a current fog amount.

13. The vehicle of claim 11, wherein the plurality of auto-defogging modes includes:
a first mode of performing the defogging control in an outdoor air circulation mode;
a second mode of switching the air circulation mode in response that an outdoor air blocking condition is satisfied or expected to be satisfied; and
a third mode of performing the defogging control preferentially in an indoor air circulation mode.

14. The vehicle of claim 13, wherein the controller is further configured to maintain the outdoor air circulation mode at all times in the defogging control in the first mode.

15. The vehicle of claim 13, wherein in the second mode, when the outdoor air blocking condition is satisfied, the defogging control is performed in the indoor air circulation mode, and when the outdoor air blocking condition is expected to be satisfied, the defogging control is performed in the outdoor air circulation mode until the outdoor air blocking condition is satisfied.

16. The vehicle of claim 15, wherein the outdoor air blocking condition is expected to be satisfied includes a case where there is an air quality deterioration section ahead.

17. The vehicle of claim 16, wherein the controller is further configured to determine a time point of entering the defogging control considering a remaining distance to the air quality deterioration section so that defogging is completed before entering the air quality deterioration section.

18. The vehicle of claim 13, wherein a reference fog amount configured to enter the defogging control in the third mode is lower than those of the first mode and the second mode.

19. The vehicle of claim 13, wherein in the third mode, when a preset reference fog amount reduction ratio is not satisfied while performing the defogging control in the indoor air circulation mode, the defogging control is performed in the outdoor air circulation mode.

20. The vehicle of claim 11, wherein the controller is further configured to learn at least one among a time point of handling a defogging button by a user and a ratio of maintaining the air circulation mode, and select any one among the plurality of auto-defogging modes based on a result of the learning.
